(19) United States
(12) Patent Application Publication
(10) Pub. No.: US 2019/0219469 A1
(43) Pub. Date: Jul. 18, 2019

(54) CAPACITIVE PRESSURE SENSOR AND METHOD FOR ITS MANUFACTURE

(71) Applicant: Endress+Hauser SE+Co. KG, Maulburg (DE)

(72) Inventors: Peter Nommensen, Villingen-Schwenningen (DE); Rafael Teipen, Berlin (DE); Benjamin Lemke, Berlin (DE); Sergej Lopatin, Lörrach (DE)

(21) Appl. No.: 15/774,488

(22) PCT Filed: Nov. 9, 2016
(86) PCT No.: PCT/EP2016/077074

§ 371 Date: May 8, 2018

(30) Foreign Application Priority Data
Nov. 9, 2015 (DE) 10 2015 119 272.1

(51) Int. Cl. G01L 9/00; G01L 19/00; G01L 13/02

(52) U.S. Cl. CPC G01L 9/0073; G01L 13/025; G01L 19/0084; G01L 19/0038

(57) ABSTRACT

A simply composed, cost effectively manufacturable, pressure sensor is described, comprising a platform, an electrically conductive measuring membrane connected with the platform to enclose a pressure chamber and contactable with a pressure to be measured, and an electrode spaced from the measuring membrane and electrically insulated from the measuring membrane to form together with the measuring membrane a capacitor with a capacitance variable as a function of a deflection of the measuring membrane dependent on the pressure acting on the measuring membrane, wherein the platform has an inner surface bounding the pressure chamber and lying opposite the measuring membrane, wherein an insulating layer is provided on the inner surface, especially an insulating layer of silicon dioxide, and the electrode is a conductive coating, especially a coating of doped polysilicon, applied on the inner surface on the insulating layer.

The present invention relates to a capacitive pressure sensor, comprising a platform, an electrically conductive measuring membrane connected with the platform to enclose a pressure chamber and contactable with a pressure to be measured, and an electrode spaced, and electrically insulated, from the measuring membrane to form together with the measuring membrane a capacitor having a capacitance variable as a function of a deflection of the measuring membrane dependent on the pressure acting on the measuring membrane.

Capacitive pressure sensors are applied in industrial measurements technology for measuring pressures. These comprise pressure sensors embodied as absolute-, relative- or pressure difference sensors referred to as semiconductor sensors or sensor chips, which can be produced by applying processes known from semiconductor technology on undivided wafers.

Pressure sensors embodied as pressure difference sensors usually have two platforms, between which the measuring membrane is arranged. Provided in each of the two platforms is a pressure chamber enclosed beneath the measuring membrane. In measurement operation, the first side of the measuring membrane is supplied via a passageway in one of the platforms with the first pressure and the second side of the measuring membrane via a passageway in the second platform with the second pressure.

Capacitive pressure sensors comprise at least one capacitive, electromechanical transducer, which registers a deflection of the measuring membrane dependent on the pressure acting on the measuring membrane, and converts such into an electrical signal reflecting the pressure to be measured. Semiconductor sensors have, for this, regularly, a conductive measuring membrane, which together with a rigid electrode integrated in the particular platform and electrically insulated from the measuring membrane, forms a capacitor having a capacitance dependent on the pressure dependent deflection of the measuring membrane.

Fundamentally, it would be possible to equip pressure difference sensors with two, one piece, conductive platforms serving simultaneously as electrode, between which would be arranged a conductive measuring membrane serving as counter electrode. For this, there is provided between the measuring membrane and each of the two platforms serving as electrode, in each case, an insulating layer, via which an outer edge of the measuring membrane is connected with the outer edge of each platform to form the two pressure chambers.

The use of such pressure difference sensors is advised against in DE 38 25 138 A1, since in the case of these pressures difference sensors there is the problem that each of the two capacitors formed through the measuring membrane and the two, one piece platforms is composed of an inner capacitor portion and an outer capacitor portion surrounding the inner capacitor portion. The inner capacitor portion is located in a region of the pressure difference sensor, in which the central region of the measuring membrane experiences the deflection dependent on the pressure difference. The outer capacitor portion is located in a region of the pressure difference sensor, in which the outer edge of the measuring membrane surrounding the central region on all sides is arranged between the insulating layers.

The capacitances C1, C2 of the two capacitors correspond to the sums of the capacitances C1a, C1b, and C2a, C2b, of the two capacitor portions, of which they are composed. In such case, however, only the capacitances C1a and C2a of the inner capacitor portions contain the metrologically to be registered, pressure difference dependence. This has the result that the metrologically to be registered, pressure difference dependent, capacitance changes ΔC1a and ΔC2a dependent on the deflection of the inner region of the measuring membrane are small in comparison to the measured capacitance given by the sum of the capacitances, C1=C1a+C1b and C2=C2a+C2b. Correspondingly, the achievable accuracy of measurement is very small. Moreover, the differential change f of the two capacitances C1, C2, which is regularly utilized in pressure measuring technology for ascertaining the pressure difference and which is determined based on the ratio of the difference C1−C2 between the two capacitances to their sum C1+C2 according to: F=(C1−C2)/(C1+C2), does not have the desired linear dependence on the pressure difference to be measured.

These disadvantages are especially noticeable in the case of pressure difference sensors with square cross-section, especially since the electrode area operative for the capacitances C1b, C2b of the outer capacitor portions is especially large in the case of measuring membranes and platforms with correspondingly square cross-section. Semiconductor sensors manufacturable on undivided wafers have, however, regularly square cross-sections, since square cross-sections enable the pressure difference sensors manufactured on undivided wafers to be separated out by sawing along straight saw lines.

This problem is overcome in the state of the art in the manner described e.g. in DE 38 25 138 A1 and in DE 103 93 943 B3, wherein the platforms applied on both sides of the measuring membrane are constructed of three mutually facing layers. These platforms have each a conductive layer facing the measuring membrane and a conductive layer facing away from the measuring membrane and these conductive layers are insulated from one another by an insulating layer arranged between the two conductive layers. In the conductive layer facing the measuring membrane, in each case, at least one furrow is provided in the form of a closed ring extending down to the insulating layer, in order to divide the layer into an inner region surrounded by the furrow and serving as an electrode and an outer region surrounding the furrow externally and connected with the measuring membrane. In such case, the inner region is structured in such a manner that it is spaced from the measuring membrane.

The manufacture of such pressure difference sensors is comparatively complicated, since each platform is constructed of a number of layers, which must, in each case, be structured, and the electrodes enclosed in the platforms must be electrically contacted through the outer layer and the insulating layer of each platform.

For reducing the negative influences of parasitic capacitances, DE 103 93 943 B3 describes shielding the electrodes integrated in the platforms from the environment of the pressure difference sensor by grounding or connecting to a reference potential the measuring membrane, the edge regions of the membrane-facing layers and the membrane-facing away layers via an electrically conductive coating applied on the outer surface of the pressure difference sensor. A coating of external sides of pressure sensors manufactured on undivided wafers is, however, only subsequently possible, after the separating of the pressure sensors. The coating of each individual pressure sensor is complicated and less precise in comparison to processes executable cost effectively on the undivided wafer.

It is an object of the present invention to provide a simply composed, cost effectively manufacturable, pressure sensor, as well as a method for its manufacture.

To this end, the invention resides in a pressure sensor, comprising
a platform,
an electrically conductive measuring membrane connected with the platform to enclose a pressure chamber and contactable with a pressure to be measured, and
an electrode spaced from the measuring membrane and electrically insulated from the measuring membrane to form together with the measuring membrane a capacitor with a capacitance variable as a function of a deflection of the measuring membrane dependent on the pressure acting on the measuring membrane,
   characterized in that
the platform has an inner surface bounding the pressure chamber and lying opposite the measuring membrane, wherein an insulating layer is provided on the inner surface, especially an insulating layer of silicon dioxide (SiO₂), and
the electrode is a conductive coating, especially a coating of doped polysilicon, applied on the insulating layer on the inner surface.

A first further development of the invention is characterized by features including that
the platform has a passageway, especially a passageway with high aspect ratio, especially an aspect ratio in the order of magnitude of 10 to 25, which extends through the platform and opens into the pressure chamber,
the insulating layer applied on the inner surface of the platform is a portion of an insulating layer applied on the platform and extending from the inner surface over a lateral surface of the passageway to a connection region provided on an outer surface of the platform, and
the electrode is a portion of a conductive coating, which extends on the insulating layer from the inner surface over the lateral surface of the passageway to the connection region provided on the outer surface of the platform.

Additionally, the invention includes a further development of the first further development, characterized in that
a recess is provided on an outer edge of the platform, especially a recess with a height, which corresponds to a thickness of the platform minus the height of the pressure chamber,
the connection region is provided on a lateral surface of this recess extending perpendicular to the measuring membrane,
on the conductive coating an electrode terminal is provided, especially a metallizing applied on the conductive coating and having a contact area arranged in the connection region for contacting the electrode connection, especially for contacting by means of wire-bonding.

A second further development of the invention provides that
on an outer edge of the platform a recess is provided exposing an edge region of the measuring membrane,
a membrane terminal connected with the exposed edge region of the measuring membrane is provided, especially a membrane terminal formed by a metallizing, for electrically connecting the measuring membrane,
the recess has a lateral surface extending perpendicular to the measuring membrane and
the membrane terminal has a contact area arranged on this lateral surface for contacting of the membrane terminal, especially for contacting by means of wire-bonding.

A further development of the pressure sensor according to the further development of the first further development and the second further development provides that
the pressure sensor has four external sides and two mutually opposing end faces and
the recess for the membrane terminal and the recess for the electrode terminal are provided on the same external side of the pressure sensor and especially are isolated from one another by an edge region of the platform located therebetween.

A first embodiment of the invention provides that
the platform has an edge region externally surrounding the pressure chamber and
a surface of the edge region facing the measuring membrane is connected with an outer edge of the measuring membrane, especially directly or via a connecting layer arranged between the surface of the edge region of the platform and the measuring membrane, especially a connecting layer embodied as a portion of an insulating layer comprising the insulating layer applied on the inner surface.

A second embodiment of the invention provides that the platform is a one piece platform.

A third further development of the invention provides that the insulating layer has a coating thickness, especially a coating thickness essentially equal in all portions of the insulating layer, in the order of magnitude of 1 μm to 5 μm.

A fourth further development of the invention provides that the conductive coating forming the electrode or comprising the electrode as a subregion has a coating thickness, especially a coating thickness essentially equal in all portions, in the order of magnitude of 50 nm to 1000 nm, especially 150 nm to 250 nm.

A variant of the pressure sensors of the invention is characterized by features including that
on a side of the measuring membrane facing away from the platform, there is provided a second platform, especially an equally constructed, second platform, connected with the measuring membrane to enclose a pressure chamber,
a first side of the measuring membrane is contactable with a first pressure via a passageway in the platform opening into the pressure chamber of the platform, and a second side of the measuring membrane is contactable with a second pressure via a passageway in the second platform opening into the pressure chamber of the second platform.

An embodiment of this variant is characterized by features including that
the second platform is equipped with an electrode and an electrode terminal connected therewith, wherein, especially, the electrodes and electrode terminals provided on both platforms, as well as their arrangement and connections, are equally embodied and/or
the second platform is equipped with a membrane terminal connected with the measuring membrane, wherein, especially, the membrane terminals provided on both platforms, as well as their arrangement and connections, are equally embodied.

Additionally, the invention includes a pressure measuring transducer with a pressure sensor according to the variant or its embodiment, characterized in that the pressure sensor is clamped perpendicularly to the measuring membrane between two support bodies, which, in each case, include a pressure transfer line, via which the pressure chamber enclosed in the adjoining platform is contactable in measurement operation with the appropriate pressure.

Moreover, the invention includes a method, especially a method executable on undivided wafers, for manufacturing pressure sensors of the invention, characterized in that
platforms are manufactured from a wafer, especially a silicon wafer, especially a p- or n-doped silicon wafer,
insulating layers are applied on surfaces of the platforms, especially in a wet oxidation method, especially by oxidation and following structuring,
conductive coatings are applied, especially by chemical gas phase deposition, especially of doped polysilicon, on the insulating layers, especially conductive coatings forming the electrodes or comprising the electrodes as portions of the conductive coatings, and structuring is performed,
the platforms on an undivided wafer are connected, especially connected by silicon direct bonding, with a wafer, especially an SOI-wafer, having a conductive cover layer, in such a manner that the cover layer borders on the end faces of the platforms facing the measuring membranes in the finished pressure sensors and
the wafer having the cover layer is removed, except for its cover layer forming the measuring membranes.

A further development of the method of the invention for manufacturing pressure sensors of the invention according to the variant or to its embodiment provides that
second platforms are manufactured from an additional wafer, especially a silicon wafer, especially a p- or n-doped silicon wafer,
especially, insulating layers are applied on surfaces of the second platforms, especially in a wet oxidation method, especially by oxidation and following structuring, and conductive coatings are applied on the insulating layers, especially coatings forming the electrodes or coatings comprising electrode portions, especially by chemical gas phase deposition, especially of doped polysilicon, and structuring is performed, and
the additional wafer is then connected with the composite of wafer and cover layer in such a manner that the pressure chambers of the platforms and the second platforms lie on both sides of the measuring membranes.

A further development of the method of the invention or its further development provides that the manufacture of the platform and/or the second platform occurs in such a manner that
in an etching method, especially deep reactive ion etching (DRIE), executed with a unitary etching depth, recesses forming the pressure chambers and recesses in the pressure sensors forming measuring membrane facing portions of the recesses to be provided for the membrane terminals are produced, and
in an etching method, especially deep reactive ion etching (DRIE), executed with a unitary etching depth, the passageways opening into the pressure chambers, the recesses for the electrode terminals and the measuring membrane remote portions of the recesses for the membrane terminals are produced.

The pressure sensors of the invention have, due to the electrode of the invention formed as a coating, the advantage that one piece platforms can be applied without defects as regards the achievable accuracy of measurement. A significantly more complicated construction of the platform for manufacture from a number of appropriately structured layers is, thus, not required.

Since both the conductive coating comprising the electrode as well as also the insulating layer located therebeneath, as applied on the given surfaces, are layers, which can be produced by means of known methods of semiconductor technology also on lateral surfaces of comparatively deep recesses or passageways with smaller cross sectional area and especially also on lateral surfaces extending perpendicular to the measuring membrane, with exactly predeterminable and uniform coating thickness within the layers, the electrical connection of the electrode can occur using a passageway with higher aspect ratio leading through the platform and utilized preferably simultaneously also for pressure loading of the measuring membrane. One piece platforms with passageways with higher aspect ratios offer the advantage of a greater mechanical stability.

Since all electrical connections of the pressure sensor are arranged on lateral surfaces of recesses extending perpendicularly to the measuring membrane and arranged on the outer edge of a single outer side of the sensor, the pressure sensors of the invention can be connected in very efficient and reliable manner, especially by means of wire bonding, to an electrical circuit, especially a measuring electronics.

The invention and its advantages will now be explained in greater detail based on the figures of the drawing, in which two examples of embodiments are shown. Equal elements are provided in the figures with equal reference characters. The figures of the drawing show as follows:

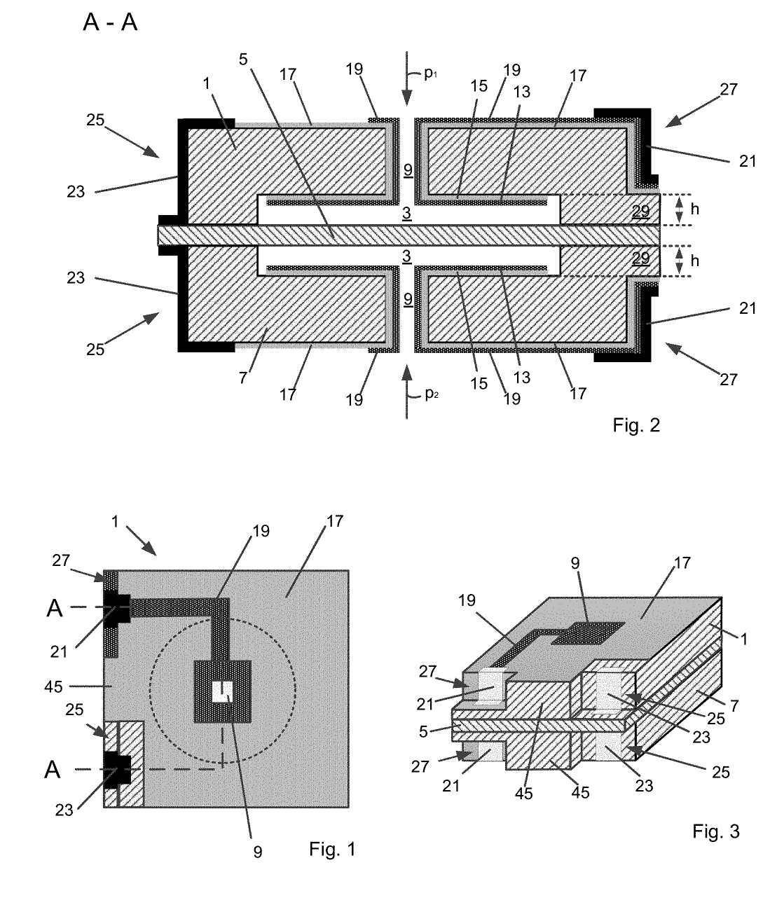

FIG. 1 a plan view of a pressure sensor of the invention;

FIG. 2 a sectional drawing of the pressure sensor of FIG. 1 viewed according to the cutting surface A-A of FIG. 1;

FIG. 3 a perspective view of the pressure sensor of FIG. 1;

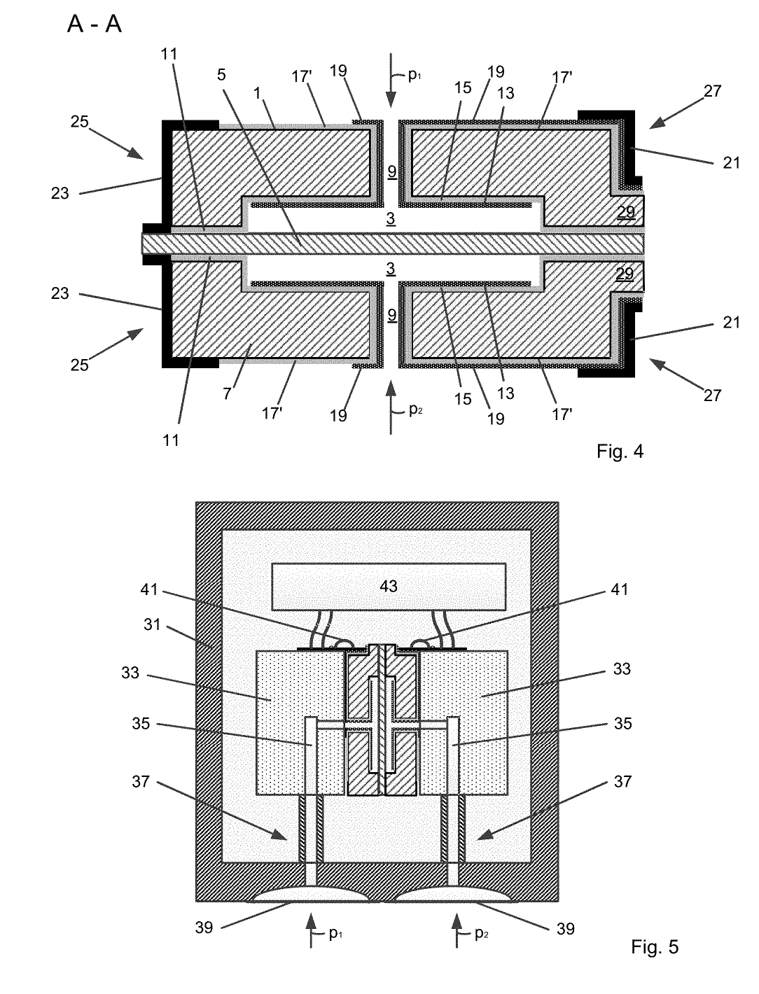

FIG. 4 a variation of the pressure sensor of FIG. 1, in the case of which the measuring membrane is connected with the platforms via connecting layers;

FIG. 5 a pressure measuring transducer; and

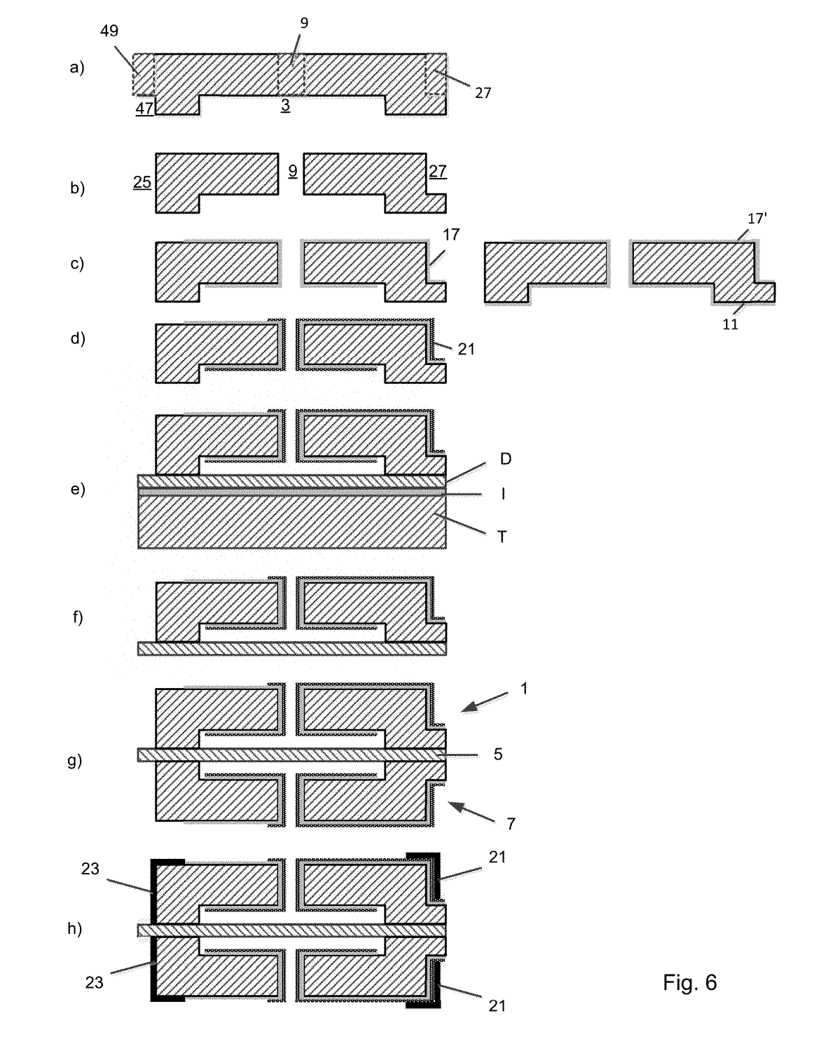

FIG. 6 method steps for manufacturing a pressure sensor of FIGS. 1-3.

FIG. 1 shows a plan view of a pressure sensor of the invention. FIG. 2 shows a sectional drawing of this pressure sensor viewed according to the cutting surface A-A of FIG. 1, and FIG. 3 shows a perspective view of this pressure sensor.

The pressure sensor of FIGS. 1-3 includes a platform 1 and a measuring membrane 5 connected with the platform 1 to enclose a pressure chamber 3. The pressure sensor is embodied in the illustrated example of an embodiment as a pressure difference sensor and includes, for this, on the side of the measuring membrane 5 away from the platform 1, a preferably equally formed, second platform 7, which is connected with the side of the measuring membrane 5 facing the second platform 7 to enclose a pressure chamber 3. The pressure chambers 3 are disk shaped, e.g. circular disk shaped, recesses in the platforms 1, 7 open toward the measuring membrane 5.

Measuring membrane 5 is composed of an electrically conductive material, e.g. p- or n-doped silicon. Suited for doping silicon is e.g. boron, aluminum or phosphorus. Preferably, the two platforms 1, 7 are also of this material.

Measuring membrane 5 is contactable with a pressure to be measured. In the case of pressure difference sensors, the pressure to be measured is a pressure difference Δp, which equals a difference between a first pressure p₁ acting on the first side of the measuring membrane 5 and a second pressure p₂ acting on the second side of the measuring membrane 5. For this, the two platforms 1, 7 have, in each case, a preferably centrally arranged passageway 9, which extends through the platforms 1, 7, opens into the associated pressure chamber 3, and via which the side of the measuring membrane 5 facing it is contactable with the first, or the second, pressure p₁, p₂, as the case may be.

Both platforms 1,7 have externally surrounding their pressure chamber 3 an outer edge, whose surface facing the measuring membrane 5 is directly connected with an outer edge of the side of the measuring membrane 5 facing it. Alternatively, a connecting layer 11, e.g. an insulating layer, e.g. of silicon dioxide (SiO₂), can be provided, in each case, between the surfaces of the platforms 1, 7 and the edge of the measuring membrane 5 to be connected therewith. An example of an embodiment for this, which apart from the connecting layers 11 is the same as the example of an embodiment illustrated in FIGS. 1-3, is shown in FIG. 4.

If measuring membrane 5 and platforms 1, 7 are, in each case, connected via a connecting layer 11, then measuring membrane 5 and platforms 1, 7 can be composed of the same material or different materials, e.g. have different dopings.

If measuring membrane 5 and platforms 1, 7 are directly connected together, thus without interpositioning of a connecting layer 11, then they are preferably of the same material and have the same doping. In this way, it is made possible that measuring membrane 5 and platforms 1, 7 can be placed at the same electrical potential.

Alternatively, measuring membrane 5 and platforms 1, 7 can also in the case of this variant be of different materials, e.g. have different dopings. In that case, measuring membrane 5 and platforms 1, 7 can be connected together via an electrically conductive connection, e.g. a metallizing, via which they can be placed at the same potential.

Both platforms 1, 7 have, in each case, an inner surface bounding the therein enclosed pressure chamber 3, facing the measuring membrane 5, lying opposite the measuring membrane 5, and spaced from the measuring membrane 5. Applied on such inner surface is an insulating layer 15. Applied on the insulating layer 15 is a conductive coating serving as electrode 13. Preferably also provided on the inner surface of the second platform 7 is a preferably equally embodied, insulating layer 15, on which a preferably likewise equally embodied electrode 13 is applied.

Each of the electrodes 13 forms with the measuring membrane 5 serving as counter electrode, in each case, a capacitor with a capacitance variable as a function of the deflection of the measuring membrane 5 dependent on the pressure Δp acting on the measuring membrane 5.

The insulating layers 15 arranged on the inner surfaces of the platforms 1, 7 are preferably, in each case, embodied as portions of insulating layers 17, 17′ applied on the platforms 1, 7, which extend from the inner surfaces over a lateral surface of the passageways 9 in the platforms 1, 7 to a connection region provided on an outer surface of each of the platforms 1, 7 for electrical connection of the electrodes 13.

In the case of the form of embodiment of FIG. 4, preferably also the connecting layers 11 are embodied as a portion of the insulating layer 17′. Correspondingly, the insulating layers 17′ provided in FIG. 4 extend starting from the inner surface of each of the platforms 1, 7 supplementally over the particular end of each of the platforms 1, 7 facing the measuring membrane 5.

Analogously, the electrodes 13 formed as conductive coatings are preferably, in each case, a portion of a conductive coating 19, which extends on the insulating layer 17, 17′ from the inner surface via the lateral surface of the passageway 9 to the connection region provided on the outer surface of each of the platforms 1, 7. This offers the advantage that for the electrical connection of the electrodes 13 neither a separate connection line, nor an additional recess or feedthrough extending through the platforms 1, 7, needs to be provided in the platforms 1, 7.

The insulating layers 17, 17′ are composed e.g. of silicon dioxide (SiO₂). For achieving a sufficient electrical insulation, a coating thickness of the insulating layers 15, 17, 17′ in the order of magnitude of a number of atoms layers is sufficient. For reducing parasitic capacitances, however, preferably a greater coating thickness, especially a coating thickness in the order of magnitude of 1 μm to 5 μm is provided.

The conductive coatings 19 forming the electrodes 13, i.e. comprising the electrodes 13, are e.g. of doped polysilicon. The coatings 19 have preferably a coating thickness in the order of magnitude of greater than or equal to 50 nm and less than or equal to 1000 nm. In an especially preferred form of embodiment, they have a coating thickness of greater than or equal to 150 nm and less than 250 nm. The doping for an n-doping can be e.g. with phosphorus, antimony or arsenic, and a p-doping can be e.g. with boron or aluminum.

Provided on both platforms 1, 7 on the conductive coatings 19 extending over the connection regions are electrode terminals 21. Suited as electrode terminals 21 applied on the coatings 19 are e.g. metallizings, e.g. of aluminum, on which a preferably planar contact area is provided, on which the contacting can occur e.g. by means of wire bonding.

Additionally, at least one membrane terminal 23 is provided, via which the measuring membrane 5 is electrically connectable. Fundamentally in the case of pressure difference sensors, a single membrane terminal 23 suffices. Pressure difference sensors can alternatively, however, also be equipped with two—preferably equally formed—membrane terminals 23. For this, a recess 25 exposing an edge region of the measuring membrane 5 is provided on an outer edge of at least one of the two platforms 1, 7. Suited as membrane terminals 23 are metallizings, e.g. of aluminum, which are applied on the edge region of the measuring membrane 5 exposed by the particular recess 25, and extend from the measuring membrane 5 over a lateral surface of the recess 25 to a connection region provided on an outer lateral surface of each of the platforms 1, 7 for connecting the measuring membrane 5. Also provided on the membrane terminals 23 in the connection regions are preferably planar contact areas, where the contacting can occur e.g. by means of wire bonding.

The capacitors formed by the electrodes 13 of the invention and the measuring membrane 5 behave as regards the pressure-dependently variable part of their capacitances exactly as in the case of the capacitances of the pressure sensors with multi-ply platforms described above, in the case of which an inner region of a membrane-facing layer of each platform separated by a furrow descending to the insulating layer serves as electrode.

In such case, membrane terminals 23 provided on both platforms 1, 7 offer the advantage that the two platforms 1, 7 are connected via the membrane terminal 23 extending, in each case, therebetween electrically conductively with the measuring membrane 5 and, thus, lie at the same potential as the measuring membrane 5. To the extent that only one membrane terminal 23 is provided, the platform 1, 7 oppositely lying it is preferably likewise connected to this potential. The two membrane terminals 23 are preferably connected to a reference potential or grounded. Alternatively, they can be connected to an electrical circuit (not shown), which keeps the measuring membrane 5 and the two platforms 1, 7 at a ground- or reference potential of the circuit. The membrane terminals 23 fulfill, thus, simultaneously the function of the coating described in the above mentioned DE 103 93 943 B3, which is there subsequently applied on the external sides of the pressure sensor. They provide a shielding of the electrodes 13 from the environment of the pressure sensor and enable keeping the potentials stable in the immediate vicinity of the electrodes 13 in the interior of the pressure sensor.

The contacting of the electrode terminals 21 and the membrane terminals 23 can occur e.g. by wire bonding, soldering or contacting with conductive adhesives. Both the wire bonding as well as also the soldering mean certain minimum requirements as regards accessibility and orientation of the contact areas.

In this connection, the unpublished German patent application of the applicant dated 30.10.2014 bearing Application No. 10 2014 115803.2 describes a pressure difference sensor, in the case of which a reliable contacting of its membrane- and electrode terminals is achieved by providing the contact areas of the connections on lateral outer surfaces of the sensor, which extend essentially perpendicularly to the measuring membrane. This solution is preferably also provided in the case of the pressure sensors described here.

For this, the recesses 25 on the edges of the platforms 1, 7 are preferably essentially prismatic, or have at least, in each case extending perpendicularly to the measuring membrane 5, lateral surfaces, on which the contact areas of the membrane terminals 23 are provided.

Additionally, there is also provided for the electrode terminals 21 on the outer edge of each of the platforms 1, 7, in each case, a preferably essentially cuboid-shaped recess 27, which, in each case, has extending perpendicular to the measuring membrane 5 a lateral surface, on which the contact area of each electrode terminal 21 is provided. In contrast to the recesses 25 provided for the membrane terminals 23, these recesses 27 do not, however, extend to the measuring membrane 5, but, instead, end within the respective platforms 1, 7, so that between recess 27 and measuring membrane 5, in each case, an edge segment 29 of each of the platforms 1, 7 remains. In such case, the insulating layers 17, 17′ and the thereon applied conductive coatings 19 extend, in each case, over the lateral surface of the respective recess 27 extending perpendicular to the measuring membrane 5 and to the surface of the edge segment 29 facing away from the measuring membrane 5.

In the case of pressure sensors with square or rectangular cross-section, which have, correspondingly, four external sides and two oppositely facing end faces on both sides of the measuring membrane 5, the membrane- and electrode terminals 21, 23 are preferably provided all on the same external side of the pressure sensor. That offers the advantage that no place for them on the two end faces needs to be kept free, and the pressure sensor can be clamped perpendicularly to the measuring membrane 5 without any special measures needing to be taken.

FIG. 5 shows, for this, an example of an embodiment of a pressure measuring transducer, in which a pressure difference sensor of the invention is clamped in a measuring transducer housing 31 perpendicularly to the measuring membrane 5 between two support bodies 33. Each support body 33 is equipped with a pressure transfer line 35, whose one end is connected via the passageway 9 in the particular platform 1, 7 with the therein enclosed pressure chamber 3, and whose other end is connected, in each case, with a frontally connected, pressure transfer means 37. The pressure transfer means 37 have, in each case, a pressure receiving chamber outwardly closed by an isolating diaphragm 39, and are, same as the pressure transfer lines 35, the passageways 9 and the pressure chambers 3, filled with a pressure transmitting liquid, which transmits the pressures p₁, p₂ acting externally on the two isolating diaphragms 39 to the two sides of the measuring membrane 5. The membrane terminals 23 and the electrode terminals 21 are located preferably on the external side of the pressure sensor facing away from the pressure transfer means 37, and are, in each case, connected via a wire bonding 41 to a connection provided on the adjoining support body 33. The connections are e.g. connections to a circuit board provided on the neighboring support body 33 or an on-site electronics, which, in turn, can be connected to a measuring electronics 43.

The invention can be applied completely analogously in connection with variations of the embodiments of the here illustrated pressure sensors. Examples for this are pressure difference sensors, in the case of which only one of the two platforms 1, 7 is equipped with an electrode 13 and/or a membrane terminal 23.

A further example is provided by relative pressure sensors, which differ from the described pressure difference sensors in that the second platform 7 is absent, and the exterior of the measuring membrane 5 is supplied with the pressure to be measured p, while its inner side bears a reference pressure P_{ref} supplied to the pressure chamber 3 via the passageway 9 in the platform 1.

Fundamentally, it is also possible to construct pressure sensors of the invention with one platform 1 and a measuring membrane 5 as absolute pressure sensors. These can be produced from the aforementioned relative pressure sensors by sealing the pressure chamber 3 enclosed in the platform 1 by plugging the passageway 9 under vacuum with an electrical insulator.

The pressure sensors of the in invention are manufacturable in simple and cost effective manner on undivided wafers. FIG. 6 shows, for this, the intermediate products produced in such case in the method steps a)-h) again using the cutting surface A-A indicated in FIG. 1.

In such case, the platforms 1 are produced from a simple, single ply wafer, e.g. a p- or n-doped, silicon wafer, in which the recesses forming the pressure chambers 3, the passageways 9 opening into the pressure chambers 3 and the recesses 25, 27 for the membrane- and electrode terminals 21, 23 of the pressure sensors are produced. For this, the corresponding regions of the wafer are removed e.g. by etching, e.g. by deep reactive ion etching (DRIE). In such case, the platforms 1 are preferably arranged pairwise in the wafer in such a manner that the recesses 25 for the membrane terminals 23 of a pair of platforms 1 directly adjoin one another in such a manner that they form together a cuboid-shaped recess with correspondingly twice as great cross-section, and the recesses 27 for a pair of electrode terminals 21 directly adjoin one another in such a manner that they form together a cuboid-shaped recess with correspondingly twice as great cross-section. In such case, there remains on the edge of the respective individual platform 1 between the recesses 25, 27 produced on its edge, in each case, an edge region 45 of each platform 1, which isolates the recesses 25, 27 from one another. The edge regions 45 mean that the individual platforms 1 also remain connected together in the wafer after the producing of the recesses 25, 27, so that the manufacturing process can be continued on the undivided wafer.

The manufacture of the platforms 1 occurs preferably in etching methods executed per side, first from a first side and then from the oppositely lying, second side of the wafer, in each case, with a unitary etching depth. For this, the recesses 27 for the electrode terminals 21 are dimensioned in such a manner that they have, in each case, a height, which equals the thickness of the platform 1 minus the height h of the pressure chambers 3. Additionally, the recesses 25 for the membrane terminals 23 are, in each case, divided into two portions 47, 49, of which one lies in the plane of the pressure chambers 3 and has the same height h as the pressure chambers 3, and the other completes the recess 25.

In this way, in method step a), from the side forming in FIG. 6 the lower side of the wafer, the recesses forming the pressure chambers 3 and the lower portions 47 of equal height h for the recess 25 for the membrane terminals 23 can be produced in a single etching procedure executed with unitary etching depth.

Then, in method step b), from the side forming the upper side of the wafer in FIG. 6, in a single etching procedure executed with unitary etching depth, the passageways 9 for the pressure supply, the recesses 27 for the electrode terminals 23 and the second portions 49 of the recesses 25 for the membrane terminals 23 are produced. The regions to be removed in such case are indicated in method step a) as wafer regions equipped with dashed boundaries.

In the following method step c), the insulating layers 17, 17′ are applied. For this, for example, a wet oxidation method can be used, with which by oxidation and following structuring a silicon oxide layer is produced on the appropriate surfaces. In the case of manufacture of pressure sensors of FIG. 4, the connecting layers 11 are simultaneously also produced in this method step. This variation is shown to the right in method step c).

In the following method step d), the conductive coatings 19 are applied on the individual platforms 1. The applying of conductive coatings 19 of doped polysilicon occurs e.g. by deposition from the gas phase (LP-CVD) at low pressure. In contrast to metallizing applied in a sputter process, whose coating thickness can vary, especially in difficultly accessible regions, the insulating layers 17, 17′ and the conductive coatings 19 can be produced in the above described manner also on lateral surfaces of passageways with high aspect ratio with essentially equal coating thickness in all portions. This holds true especially for passageways with lateral surfaces extending in the pressure sensor perpendicularly to the measuring membrane 5.

This offers the advantage that the passageways 9 used for the electrical connection of the electrodes 13 and preferably simultaneously for pressure loading can be longer and/or have a smaller cross sectional area than in the case of conventional pressure sensors.

In such case, passageways 9 with an aspect ratio in the order of magnitude of 10 to 25 are implementable, which in the case of passageways 9 with square cross-section corresponds to a ratio of the length of the passageway 9 to the length of a side in this order of magnitude.

Thus, platforms 1, 7 with a thickness in order of magnitude of 300 μm to 500 μm can have, for example, passageways 9 with a square cross-section with a side length of greater than or equal to 20 μm. The side lengths lie e.g. in the range from 20 μm to 100 μm, and preferably in the range from 20 μm to 30 μm. Aspect ratios in the above-referenced order of magnitude are naturally completely analogously implementable also in connection with passageways 9 with circularly shaped cross-sections.

One piece platforms 1, 7, especially one piece platform 1, 7 with passageways 9 with greater depth and/or smaller cross sectional area mean increased mechanical stability of the pressure sensors. In the case of pressure difference sensors, there is achieved thereby an improvement of the overload strength of the pressure sensors, especially relative to overloads acting unilaterally on the measuring membrane 5, as well as an improved resistance of the pressure sensors against a system pressure superimposed on the pressure difference to be measured Δp. The system pressure refers to a pressure acting equally on the two sides of the measuring membrane 5 and superimposed on the pressure difference to be measured Δp. The system pressure corresponds to the lower of the two pressures p₁, p₂ acting on the measuring membrane 5.

Moreover, passageways 9 with great depth and less cross-section act as regards the pressure transfer effected by them as a throttle and increase, thus, the overload strength of the pressure sensor against dynamic overloads.

Then, in method step e), a wafer having a conductive cover layer D, especially an SOI-wafer having support layer T, an insulating layer I arranged thereon and a conductive cover layer D arranged on the insulating layer I, is connected with the wafer worked according to the method steps a)-d) in such a manner, e.g. by silicon direct bonding, that its cover layer D forming the measuring membranes 5 of the pressure sensors seals the pressure chambers 3 produced in the first wafer. In the case of the manufacture of the pressure sensors of FIG. 4, the corresponding connection can likewise be effected by bonding, wherein the bonded connection occurs via the connecting layer 11.

Then, in method step f, the support layer T and the insulating layer I of the SOI-wafer are removed. Suited for removal of the support layer T are etching methods, such as e.g. deep reactive ion etching (DRIE). Suited for removal of the insulating layer I are, for example, dry etching methods, such as e.g. reactive ion etching (RIE).

In parallel with manufacture of the platforms 1 or following thereon, second platforms 7 are manufactured from an additional wafer based on the method steps a) to d) and provided with the insulating layers 17, 17′ and the conductive coatings 19. To the extent that only one of the two platforms 1, 7 should be equipped with a membrane terminal 23 and/or an electrode 13, the corresponding method steps are omitted, or correspondingly modified.

Then, the other wafer processed in this way is, in method step g), connected with the composite of the cover layer D forming the measuring membranes 5 and the first wafer in such a manner that the pressure chambers 3 of the first and second platforms 1, 7 lie, in each case, opposite one another. Also, this connection is produced e.g. by bonding, e.g. by silicon direct bonding.

Following this, in method step h), the electrode terminals 21 and the membrane terminals 23 are produced by applying a metal coating on the corresponding lateral surfaces bounding the recesses 25, 27, e.g. by sputter deposition.

Then, the pressure difference sensors manufactured in this way are isolated from one another by sawing along the outer sides of the individual pressure difference sensors.

### LIST OF REFERENCE CHARACTERS

1 platform

3 pressure chamber

5 measuring membrane

7 second platform

9 passageway

11 connecting layer

13 electrode

15 insulating layer

17 insulating layer

17′ insulating layer

19 conductive layer

21 electrode terminal

23 membrane terminal

25 recess

27 recess

29 edge segment

31 measuring transducer housing

33 support body

35 pressure transfer line

37 pressure transfer means

39 isolating diaphragm

41 wire bonding

43 measuring electronics

45 edge region

47 portion of the recess 25

49 portion of the recess 25

1-15. (canceled)

16. A pressure sensor, comprising:
a first platform;
an electrically conductive measuring membrane connected with the first platform to define a first pressure chamber and contactable with a pressure to be measured; and
a first electrode spaced and electrically insulated from the measuring membrane, thereby forming with the measuring membrane a capacitor, the capacitor having a capacitance variable as a function of a deflection of the measuring membrane, the deflection dependent on the pressure to be measured,
wherein the first platform includes an inner surface bounding the first pressure chamber and opposite the measuring membrane, the inner surface including an insulating layer applied thereon, and wherein the first electrode is a conductive coating applied on the insulating layer on the inner surface.

17. The pressure sensor of claim 16, wherein the insulating layer is silicon dioxide and the conductive coating is doped polysilicon.

18. The pressure sensor of claim 16, wherein:
the first platform includes a first passageway extending through the first platform and opening into the first pressure chamber;
the insulating layer applied on the inner surface of the first platform is a portion of an insulating layer applied on the first platform and extending from the inner surface over a lateral surface of the first passageway to a connection region on an outer surface of the first platform; and
the first electrode is a portion of a conductive coating that extends over the insulating layer from the inner surface over the lateral surface of the first passageway to the connection region on the outer surface of the first platform.

19. The pressure sensor of claim 18, wherein:
the first passageway has an aspect ratio of between 10 and 25.

20. The pressure sensor of claim 18, wherein:
the first platform includes a first recess on an outer edge of the first platform, the first recess having a height corresponding to a thickness of the first platform less a height of the first pressure chamber;
the connection region extends to a lateral surface of the first recess, extending perpendicular to the measuring membrane; and
the conductive coating includes a first electrode terminal embodied as a metallizing applied on the conductive coating and having a contact area arranged in the connection region and adapted to enable contacting the first electrode terminal by wire bonding.

21. The pressure sensor of claim 20, wherein:
the first platform includes a second recess on an outer edge of the first platform, wherein the second recess exposes an edge region of the measuring membrane;
the second recess includes a lateral surface extending perpendicular to the measuring membrane;
the measuring membrane includes a first membrane terminal connected with the edge region of the measuring membrane, the measuring terminal embodied as a metallizing to enable electrically connecting the measuring membrane; and
the first membrane terminal has a contact area disposed on the lateral surface and adapted to enable contacting the first membrane terminals by wire bonding.

22. The pressure sensor of claim 21, wherein:
the pressure sensor has four external sides and two mutually opposing end faces; and
the first recess for the first electrode terminal and the second recess for the first membrane terminal are on a same external side of the pressure sensor and are insulated from one another by an edge region of the first platform located therebetween.

23. The pressure sensor of claim 16, wherein:
the first platform includes an edge region externally surrounding the first pressure chamber; and
a surface of the edge region opposite the measuring membrane is connected with an outer edge of the measuring membrane, either directly or via a connecting layer disposed between the surface of the edge region of the first platform and the measuring membrane.

24. The pressure sensor of claim 23, wherein:
the connecting layer is a portion of the insulating layer applied on the inner surface.

25. The pressure sensor of claim 16, wherein:
the first platform is a one-piece platform.

26. The pressure sensor of claim 16, wherein:
the insulating layer has a layer thickness between 1μm to 5μm, wherein the layer thickness is substantially uniform in all portions of the insulating layer.

27. The pressure sensor of claim 16, wherein:
the conductive coating, including the first electrode or including the first electrode as a subregion, has a coating thickness between 50 nm and 1000 nm, wherein the coating thickness is substantially uniform.

28. The pressure sensor of claim 16, wherein:
the conductive coating, including the first electrode or including the first electrode as a subregion, has a coating thickness between 150 nm and 250 nm, wherein the coating thickness is substantially uniform.

29. The pressure sensor of claim 16, further comprising:
a second platform on a side of the measuring membrane opposite the first platform, the second platform substantially equally embodied as the first platform and connected with the measuring membrane to define a second pressure chamber, wherein a first side of the measuring membrane is contactable with a first pressure via a first passageway in the first platform opening into the first pressure chamber, and wherein a second side of the measuring membrane is contactable with a second pressure via a second passageway through the second platform opening into the second pressure chamber.

30. The pressure sensor of claim 29, wherein:
the second platform includes a second electrode and a second electrode terminal connected therewith; and/or
the second platform includes a second membrane terminal connected with the measuring membrane.

31. The pressure sensor of claim 30, wherein:
the first electrode, the second electrode, a first electrode terminal and the second electrode terminal, including arrangement and connection thereof, are substantially equally embodied; and/or
the second membrane terminal and a first membrane terminal connected with the edge region of the measuring membrane, including arrangement and connection thereof, are substantially equally embodied.

32. The pressure sensor of claim 29, wherein:
the pressure sensor is disposed between two support bodies, each support body including a pressure transfer line via which each of the first pressure chamber and the second pressure chamber is contactable with the first pressure and the second pressure, respectively, in measurement operation.

33. A method of manufacture of a pressure sensor, the method comprising:
producing a first platform from an undivided, p- or n-doped silicon wafer, the first platform at least partially defining a first pressure chamber connectable to a first pressure and including a first passageway therethrough;
applying an insulating layer to an inner surface, a lateral surface of the first passageway and a connection region on an outer surface of the first platform using a wet oxidation method via oxidation and following structuring, the insulating layer comprising silicon dioxide;
applying a conductive coating on at least a portion of the insulating layer using chemical gas phase deposition and structuring such that the conductive coating forms a first electrode, the first electrode spaced and electrically insulated from the inner surface of the first platform;
bonding by silicon direct bonding a silicon-on-insulator wafer to the first platform, the silicon-on-insulator having a conductive cover layer on a wafer insulating layer on a support layer, wherein the cover layer is bonded to edge regions of the inner surface of the first platform;
removing the wafer insulating layer and support layer from the silicon-on-insulator wafer, thereby forming a measuring membrane bonded to the first platform, wherein the measuring membrane and the first electrode embody a first capacitor, the first capacitor having a capacitance variable as a function of a deflection of the measuring membrane, the deflection dependent on the first pressure.

34. The method of claim 33, further comprising:
producing a second platform from an undivided, p- or n-doped silicon wafer, the second platform at least partially defining a second pressure chamber connectable to a second pressure and including a second passageway therethrough;
applying an insulating layer to an inner surface, a lateral surface of the second passageway and a connection region on an outer surface of the second platform using a wet oxidation method via oxidation and following structuring, the insulating layer comprising silicon dioxide;
applying a conductive coating on at least a portion of the insulating layer using chemical gas phase deposition and structuring such that the conductive coating forms a second electrode, the second electrode spaced and electrically insulated from the inner surface of the second platform;
bonding the second platform to the measuring membrane such that the first pressure chamber and the second pressure chamber are on opposites sides of and partially defined by the measuring membrane, wherein the measuring membrane and the first electrode embody a second capacitor, the second capacitor having a capacitance variable as a function of a deflection of the measuring membrane, the deflection dependent on the first pressure and/or the second pressure.

35. The method of claim 33, wherein:
the first platform includes recesses partially defining the first pressure chamber, and defining the edge regions of the inner surface of the first platform upon which the cover layer is bonded, are produced using a deep reactive ion etching method, executed with a unitary etching depth; and
the first passageway through the first platform, recesses in the first platform in which the first electrodes are formed and recesses in the first platform in which a first membrane electrode is formed are produced using a deep reactive ion etching method, executed with a unitary etching depth.
